(19) United States
(12) Patent Application Publication
(10) Pub. No.: US 2008/0205197 A1
(43) Pub. Date: Aug. 28, 2008

(54) Device and Methods Directed to Providing Reminders to Contact Lens Wearers

(76) Inventor: William R. Martin, Dayton, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 12/065,789

(22) PCT Filed: Sep. 7, 2006
(86) PCT No.: PCT/US06/34763

§ 371 Date: Mar. 5, 2008

Related U.S. Application Data
(60) Provisional application No. 60/715,802, filed on Sep. 9, 2005.
(60) Provisional application No. 60/779,662, filed on Mar. 6, 2006.

(51) Int. Cl. G04B 47/00

(52) U.S. Cl. 368/10

(57) ABSTRACT

Devices and methods for providing reminders to a contact lens wearer comprise a timing circuit, manually actuatable controls for setting and controlling the timing circuit, and an electronic visual display responsive to the timing circuit. The electronic visual display comprises a clock display, a calendar display, and a message display configured to illuminate a reminder message instructing the contact lens wearer to replace the contact lenses and/or catalyzing platinum disks in the contact lens case. The manually actuatable controls comprise a plurality of use period actuation mechanisms, wherein each actuation mechanism corresponds to an intended period of use, and at least one reset actuation mechanism for updating the device upon replacement of the contact lenses and catalyzing platinum disk.

The present invention is directed to devices and methods for providing reminders to contact lens wearer. The device delivers a visual reminder to the contact lens wearer to replace their contact lenses and/or replace the catalyzing platinum disk in the contact lens case.

Contacts lenses are available in a number of varieties, including hard and soft. Hard contacts are typically not disposable, while soft contacts often are. Some soft contacts are also known as extended wear lenses. Extended wear lenses are soft contact lenses that typically allow the user to wear the lens for up to thirty consecutive nights and days before removal. They are discarded after the specified length of time. These contact lenses are increasing in popularity owing to their obvious convenience. Such contact lenses are able to be worn for this extended period because of their high oxygen permeability (typically five to six times greater than conventional soft lenses), which allows the eye to remain remarkably healthy. Another type of contact lenses is frequent or planned replacement soft lenses. These lenses are soft daily or extended wear lenses that are removed daily but are discarded and replaced on a planned schedule, most often every week, every two weeks, monthly, quarterly or every four months.

Additionally, some people with extremely sensitive, irritable eyes often use a contact lens cleaning solution of hydrogen peroxide. The hydrogen peroxide cleaning solution is used for disinfecting the lenses. The hydrogen peroxide cleaning solution comes with a special contact lens storage case that contains a catalyzing platinum disk. If the contact lens is soaked in the hydrogen peroxide cleaning solution with the platinum disk for at least six hours, the hydrogen peroxide decomposes and the remaining cleaning solution becomes a saline solution that will not harm the eye. Over time the platinum disk decomposes and must be replaced after every 100 cleanings or after approximately ninety days. If the catalyzing platinum disk is not replaced as recommended, the hydrogen peroxide cleaning solution does not decompose and could result to damage to the users' eyes.

It is often difficult for contact lens wearers to remember what day to replace and dispose of old contact lenses or, alternatively, what day to replace and dispose of the catalyzing platinum disk in a hydrogen peroxide cleaning solution system. This is especially true for longer periods of wear. Forgetting to change contact lens or the catalyzing platinum disk can result in serious problems for the wearer. Extending the use of the contact lens or of the catalyzing platinum disk past the recommended wear period may make the contact lens uncomfortable to wear and increases the risk of eye infection, which possibly could result in eye damage. Additionally, deposits may build up on lenses that are worn for too long a time. These deposits may make the lenses less uncomfortable to wear and may also increase the risk of eye infection. Further still, the contact lens wearer may experience irritation of the eyes, redness, or blurred vision if the lenses are worn past their period of intended use.

Accordingly, there is a need for a device with a visual reminder to allow a contact lens wearer to determine quickly when his or her contact lens or lenses or catalyzing platinum disk in a hydrogen peroxide cleaning solution system needs to be replaced. Additionally, there is a need for the contact lens wearer to determine how many days past the recommended period of wear have lapsed.

According to the present invention, a device is provided for visually reminding a contact lens wearer to dispose of and to replace his or her current contact lens at the end of the lens wear period. Alternatively, a device is provided for visually reminding a contact lens wearer to dispose of and to replace the catalyzing platinum disk after the recommended number of the cleanings, or, alternatively, the recommended replacement date for the catalyzing platinum disk, in a hydrogen peroxide cleaning solution system have elapsed. The device visually indicates when the wear period of the current contact lens has expired and the number of days past the expiration of the wear period that have elapsed. The device may also visually indicate when the catalyzing platinum disk should be replaced and the number of days past the replacement date of the catalyzing platinum disk that have elapsed. The contact lens wearer resets the device after replacing his or her old lenses or catalyzing platinum disk. The period of wear is selected by the wearer, and is visually indicated on the display. The device further permits calendar and clock features to be shown on the display. A visual reminder of the contact lens replacement day or catalyzing platinum disk replacement day is marked on the calendar feature. The device can be portable and have at least one alarm.

Accordingly, it is a feature of the embodiments of the present invention to provide a device with a visual reminder to the contact lens wearer to discard worn contact lenses and replace his or her contact lenses at the expiration of the recommended wear period of the contact lenses.

It is another feature of the embodiments of the present invention to provide a device with a visual reminder to the contact lens wearer to discard and replace the catalyzing platinum disk in a hydrogen peroxide cleaning solution system after the recommended number of cleanings, or after the recommended replacement date for the catalyzing platinum disk, for the contact lenses.

It is another feature of the embodiments of the present invention to provide a visual display of the number of days that have elapsed since the recommended contact lens use or wear period has expired.

It is another feature of the embodiments of the present invention to provide a visual display of the number of days that have elapsed since the recommended replacement day of the catalyzing platinum disk.

Other features of the embodiments of the present invention will be apparent in light of the description of the invention embodied herein.

The detailed description of specific embodiments of the present invention can be best understood when read in conjunction with the following drawings, where like structure is indicated with like reference numerals and in which:

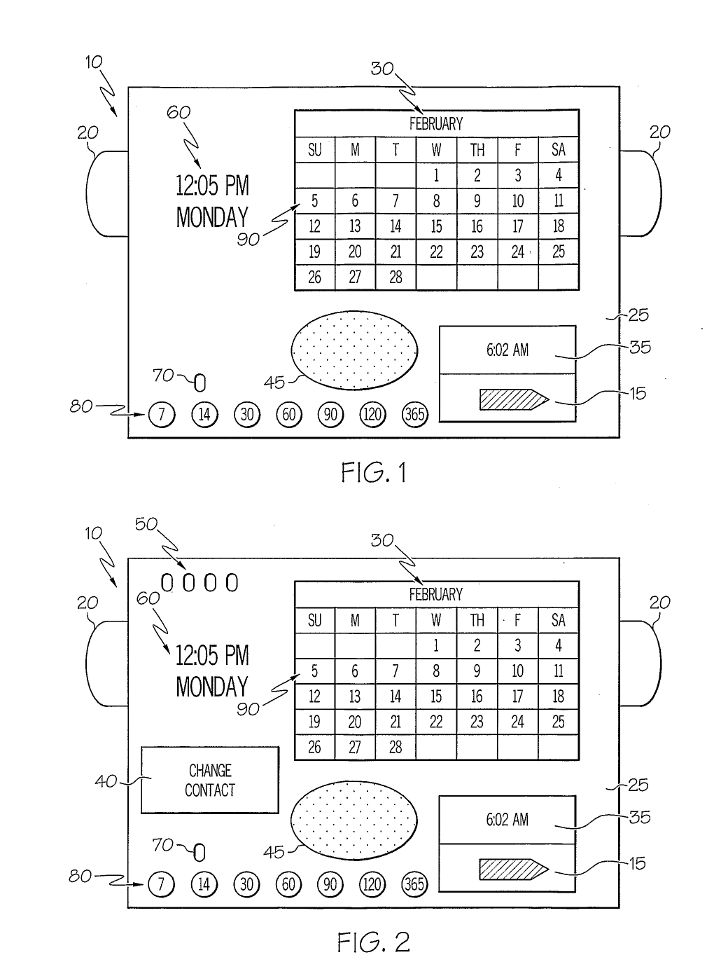

FIG. 1 is an illustration of a front view of a display of a contact lens reminder device according to one or more embodiments of the present invention.

FIG. 2 is an illustration of a front view of a display of a contact lens reminder device that reminds a contact lens wearer to replace his or her contacts or catalyzing platinum disk according to one or more embodiments of the present invention.

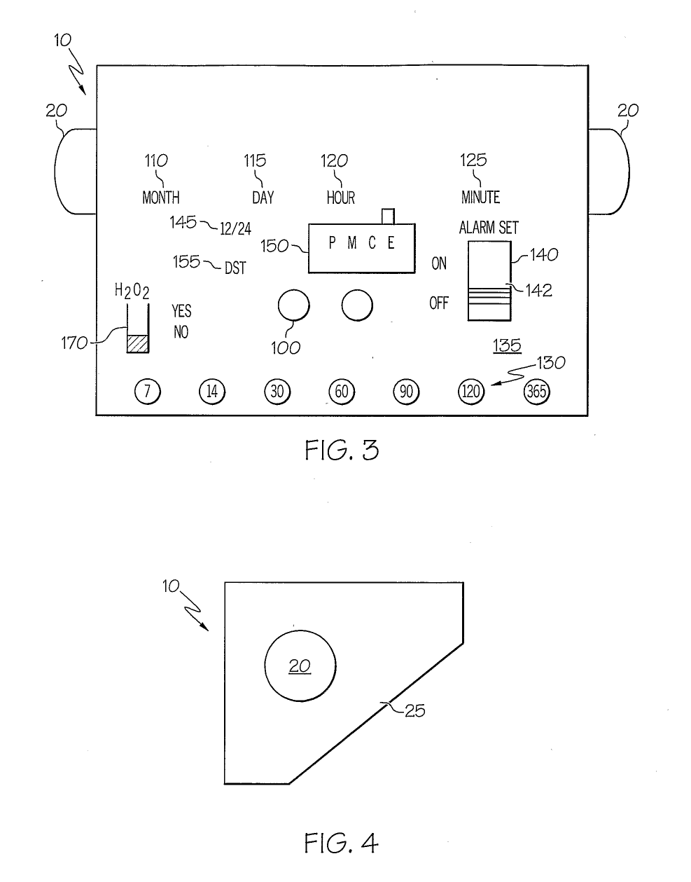

FIG. 3 is an illustration of a back view of a contact lens reminder device according to one or more embodiments of the present invention.

FIG. 4 is an illustration of a side view of a contact lens reminder device according to one or more embodiments of the present invention.

In the following detailed description, reference is made to the accompanying drawings that form a part of the description, and in which are shown by way of illustration, and not by way of limitation, specific embodiments in which the invention may be practiced. It is to be understood that other embodiments may be utilized and that logical, mechanical and electrical changes may be made without departing from the spirit and scope of the present invention.

Referring initially to FIG. 1, a device 10 is illustrated having an electronic display 25 that incorporates a calendar display 30 and a clock display 60. In addition to the display 25, the device 10 comprises a timing circuit (not shown), and manually actuatable controls for setting and controlling the timing circuit, wherein the electronic visual display is responsive to the timing circuit. The display 25 can be an LCD or any other suitable type of display. In one embodiment, the clock display 60 indicates the current time of day as well as the day of the week. Other embodiments may display the current date with month and day, or month, day and year. The clock display may display the current time of day in 12-hour or 24-hour clock format. The calendar display 30 may display the current month or, alternatively, may display the month in which the contact lens or catalyzing platinum disk should be replaced. The device 10 may incorporate an alarm which will include a speaker 45 and an alarm display 35 indicating the currently set alarm time.

The device 10 can be battery powered or, in the alternative, powered by an AC adapter (not shown). If the device 10 is battery powered, the display 25 may display a battery indicator 15 of how much battery life is left in the batteries. The amount of battery life left is indicated by shading in an outline of a battery. The amount of shading in the battery is an indication of the percentage of battery power remaining in the batteries.

The day the contact lens needs to be replaced is indicated by a small indicator 90 on the calendar display 30. Alternatively, the small indicator 90 would indicate the day that the catalyzing platinum disk needs to be replaced in a hydrogen peroxide cleaning solution system. The device 10 may comprise use period actuation mechanisms, for example, buttons 80 which correspond to the intended period of use for the contact lenses or catalyzing platinum disks. The possible intended use periods 80 are indicated along the bottom of the display, and may be displayed in terms of days in the possible wear periods, but may be displayed in other terms. For example, possible wear period could be 7, 14, 30, 60, 90, 120, and 365 days. The 365 day wear period could act as a reminder to replace a one year contact, or could remind a user that it is time for their annual eye examination. The current replacement period is indicated by a small light 70 illuminated over that current intended contact lens wear period. Typical contact lens wear periods include one week, two weeks, and a month, two months, three months or four months. However, other contact lens wear periods are possible. In this example, the replacement period is two weeks, or fourteen days.

The device further comprises at least one reset actuation mechanism, for example, a reset button or switch. In one embodiment, two reset buttons 20 are positioned on the right and left sides of the device 10. When the contact lens wearer replaces his or her lens or, alternatively, replaces the catalyzing platinum disk, both reset buttons 20 are pressed and the device 10 updates the display 25 to indicate the next replacement day for the contact lens wearer based on the selected wear period. Both reset buttons 20 need to be pressed simultaneously in order to advance and update the display 25. This requirement helps to alleviate the unintentional resetting of the display 25 by the accidental pressing of only one of the reset buttons 20.

FIG. 2 illustrates the display 25 of the device 10 after the intended contact lens wear period has expired, and the currently worn contact lenses needs to be discarded and replaced. On the display 25, a reminder message 40 appears, reminding the wearer to replace his or her contact lens. For every day after the expiration of the intended contact lens wear period, a small day-over light 50 illuminates for each day missed at the top of the display 25. For example, if the contact lens replacement day is February 5th and it is currently February 9th, four lights will be illuminated, indicating that the contact lenses then being worn are four days past their replacement date. The lights may be LEDs or any other similar type of lighting device. Once the contacts lens have been discarded and replaced, both reset buttons 20 are pressed and the intended contact lens wear period is reset, as described above. At this point, the reminder message 40 disappears from the display 25 and the small day-over lights 50 are extinguished from the display 25.

Alternatively, FIG. 2 illustrates the display 25 of the device 10 after the intended period of use for the catalyzing platinum disk in a hydrogen peroxide cleaning solution system has elapsed. On the display 25, a reminder message 40 appears, reminding the wearer to replace the catalyzing platinum disk. For every day after the expiration of the catalyzing platinum disk, a small day-over light 50 illuminates for each day missed at the top of the display 25. For example, if the catalyzing platinum disk replacement day is February 5th and it is currently February 9th, four lights will be illuminated, indicating that the catalyzing platinum disk being used is four days past its replacement date. The lights may be LEDs or any other similar type of lighting device. Once the catalyzing platinum disk has been replaced, both reset buttons 20 are pressed and the intended period of use for the catalyzing platinum disk is reset, as described above. At this point, the reminder message 40 disappears from the display 25 and the small day-over lights 50 are extinguished from the display 25. It is further contemplated to have reminder messages 40 provided in advance of the replacement date that the contact lenses of catalyzing disks need to be replaced. This message display may, in one embodiment, list the number of days until the replacement date.

FIG. 3 is a rear view of the device 10. The contact lens wearer sets the intended contact lens wear period, whether a hydrogen peroxide cleaning system is used, the date and the time by pressing buttons on the back of the device 10. If a hydrogen peroxide cleaning solution system is to be used, the switch 170 is moved to the yes position. If not, the switch 170 is moved to the no position.

The intended contact lens wear period may be selected by pressing the button 135 above the desired period of wear 130. For example, if the intended period of wear is quarterly (i.e., 90 days), the button 135 above 90 is pressed. The wear period buttons 135 can be recessed so that the period of wear cannot be accidentally changed.

The time displayed on the display 25 may be displayed in either 12-hour clock mode or in 24-hour clock mode. The format may be selected by pressing the 12/24 button 145 and toggling between the two formats. In one embodiment, to set or change the time displayed on the display 25 on the front of the device 10, the hour button 120 is pressed along with the up/down buttons 100 to change the hour displayed up or down. The same procedure is performed for the minutes using the minute button 125. The current date is set by selecting the month button 110 and the up/down buttons 100 to select the current month. The day is selected by pressing the day button 115 and the up/down buttons 100 until the correct day is displayed. If the clock display 60 also includes the year in the date displayed on the display 25, then the year is selected by pressing the year button (not shown) and the up/down buttons 100 until the correct year is displayed on the display 25.

Alternatively, the device clock may be automatically set by synchronizing itself with an atomic clock by radio frequency. The device 10 may contain an extremely small and relatively simple antenna and receiver to decode the information in the signal sent by the atomic clock and set the clock's time accurately. In this embodiment, the time zone is selected using a switch 150 to indicate the time zone the device 10 is currently in (i.e., the Pacific (P), Mountain (M), Central (C) or Eastern (E) time zones). Further, in this embodiment, the device includes a Daylight Savings Time (DST) button 155 to specify whether the device 10 is in a region that follows the Daylight Savings Time convention.

To set or change the alarm, the alarm set button 140 and the hour button 120 are pressed together simultaneously to set or change the alarm hour up one hour. The current alarm time 35 is shown on the display 25 on the front of the device 10. The two buttons, 140 and 120, are pressed until the desired alarm hour is reached. The same procedure is performed for the alarm minutes using the minute button 125 and the alarm set button 140. The alarm may be turned on and off by the alarm set switch 142.

In further embodiments, it is contemplated to have multiple alarms. For example, an additional alarm may be used to alert a user when they need to put eye drops in their eyes. In yet another example, an additional alarm could remind users with glaucoma to insert drops into their eyes once or twice a day, or as often as prescribed.

FIG. 4 illustrates the side view of the device 10. The reset button 20 can be centered in the side of the device 10. The display 25 can be positioned at an angle to facilitate the viewing of the display 25.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A device for providing reminders to a contact lens wearer comprising a timing circuit, manually actuatable controls for setting and controlling the timing circuit, and an electronic visual display responsive to the timing circuit,
the electronic visual display comprising,
a clock display configured to output the current time, the day of the week or both,
a calendar display configured to output the current month, the month in which contact lenses and/or catalyzing platinum disks of contact lens cases should be replaced, or both, and
a message display configured to illuminate a reminder message instructing the contact lens wearer to replace the contact lenses and/or catalyzing platinum disks; and
the manually actuatable controls comprising,
a plurality of use period actuation mechanisms, wherein each actuation mechanism corresponds to an intended period of use, the intended period of use being defined as the maximum time period in which a contact lens and/or a catalyzing platinum disk should be used before replacement is required; and
at least one reset actuation mechanism, wherein the reset actuation mechanism, upon triggering, is configured to set an updated date for replacement of the contact lens and/or the catalyzing platinum disk, the updated replacement date being defined as the date in which the intended period of use expires.

2. A device according to claim 1 further comprising a speaker.

3. A device according to claim 1 further comprising an at least one alarm display configured to display a set alarm time.

4. A device according to claim 1 wherein the electronic visual display is a liquid crystal display (LCD).

5. A device according to claim 1 further comprising a battery.

6. A device according to claim 5 wherein the electronic visual display comprises a battery life display configured to indicate the remaining battery life.

7. A device according to claim 1 wherein the calendar display comprises at least one indicator adjacent the day in which the contact lenses and/or catalyzing platinum disks should be replaced.

8. A device according to claim 1 further comprising an AC adaptor.

9. A device according to claim 1 wherein each use period actuation mechanism comprises a lighting element configured to be illuminated upon actuation of the mechanism.

10. A device according to claim 1 wherein the use period actuation mechanisms and the reset actuation mechanisms comprise switches, or buttons.

11. A device according to claim 1 wherein the use period actuation mechanisms comprise recessed buttons.

12. A device according to claim 1 wherein the reset actuation mechanism comprises two reset buttons being operable only if the buttons are pressed simultaneously.

13. A device according to claim 1 wherein the electronic visual display comprises an elapsed day display including a plurality of lighting elements, wherein the elapsed day display is configured to illuminate one lighting element for every day exceeding the intended period of use.

14. A device according to claim 1 further comprising an actuation mechanism configured to permit or prohibit the device from displaying a reminder message to the contact lens wearer to replace the catalyzing platinum disk upon the expiration of the intended use period.

15. A device according to claim 1 further comprising an antenna and receiver configured to automatically set the date and time by receiving and decoding a signal from an atomic clock.

16. A device according to claim 1 further comprising a time zone actuation mechanism configured to allow the contact lens wearer to set the time zone of their location.

17. A device according to claim 1 further comprising a time change actuation mechanism configured to account for Daylight Savings Time conventions.

18. A method of providing reminders to a contact lens wearer comprising:
providing an electronic device comprising an electronic visual display;
displaying the current date and at least one replacement date on the visual display, the replacement date corresponding to a date in which the contact lenses should be replaced, or corresponding to a date in which a catalyzing platinum disk present of a contact lens storage case should be replaced; and
outputting a reminder message to the contact lens wearer via the visual display that the catalyzing platinum disk, the contact lenses, or both should be replaced.

19. A method according to claim 1 wherein the reminder message occurs before the replacement date, on the replacement date, and/or after the replacement date.

20. A method of using a device directed to providing reminders to contact lens wearers comprising:
providing an electronic device comprising a timing circuit, manually actuatable controls for setting and controlling the timing circuit, and an electronic visual display responsive to the timing circuit, the manually actuatable controls comprising a reset actuation mechanism;
viewing a reminder message from the visual display, wherein the message informs the contact lens wearer to replace their contact lenses and/or replace a catalyzing platinum disk of a contact lens storage case; and
replacing the contact lenses, the catalyzing platinum disks, or both; and
resetting the device after replacement by triggering the reset actuation mechanism so that the device displays an updated replacement date, the updated replacement date being defined as the date in which an intended period of use for the contact lenses and/or the catalyzing platinum disks expires.
